(19) United States
(12) Patent Application Publication
(10) Pub. No.: US 2025/0106265 A1
(43) Pub. Date: Mar. 27, 2025

(54) SYSTEM FOR PROVIDING SERVICES THROUGH SERVICE BASED ARCHITECTURE OF COMMUNICATION NETWORK AND METHOD THEREOF

(71) Applicant: SAMSUNG ELECTRONICS CO., LTD., Suwon-si (KR)

(72) Inventor: Michal WODCZAK, Suwon-si (KR)

(73) Assignee: SAMSUNG ELECTRONICS CO., LTD., Suwon-si (KR)

(21) Appl. No.: 18/900,168

(22) Filed: Sep. 27, 2024

(30) Foreign Application Priority Data
Sep. 27, 2023 (KR) 10-2023-0130810
Dec. 12, 2023 (KR) 10-2023-0179630

(51) Int. Cl. H04L 65/1073

(52) U.S. Cl. CPC H04L 65/1073

(57) ABSTRACT

A method for providing a service, includes: receiving a service request from an external entity in a service based architecture (SBA); requesting, by an elevated plane function (EPF) of the SBA, an in-band registration or out-of-band registration for the external entity to a modified network resource function (mNRF) directly or indirectly; and based on the in-band registration or the out-of-band registration, providing at least a part of service function of the SBA to the external entity.

### CROSS REFERENCE TO RELATED APPLICATIONS

The application claims priority to Korean Patent Application Nos. 10-2023-0130810 and 10-2023-0179630, filed on Sep. 27, 2023 and Dec. 12, 2023, respectively, the entire contents of which are incorporated herein for all purposes by this reference.

### BACKGROUND

### 1. Field

The disclosure relates to an apparatus and a system for providing virtual world services.

### 2. Description of Related Art

With the development of technology, various services such as metaverse, game services, and broadcast relay services that provide virtual space services by integrating virtual reality, augmented reality, and three dimensional (3D) virtual environments through various electronic devices and high-speed network systems, or services requiring low-latency, highly reliable communication are becoming a reality.

The above information may be provided as related art for the purpose of aiding understanding of the disclosure. No claim or determination is made as to whether any of the foregoing may be applied as prior art to the disclosure.

### SUMMARY

According to an aspect of the disclosure, a method for providing a service, includes: receiving a service request from an external entity in a service based architecture (SBA); requesting, by an elevated plane function (EPF) of the SBA, an in-band registration or out-of-band registration for the external entity to a modified network resource function (mNRF) directly or indirectly; and based on the in-band registration or the out-of-band registration, providing at least a part of service function of the SBA to the external entity.

According to an aspect of the disclosure, a system for providing a service, includes a service based architecture (SBA) configured to receive a service request from an external entity, wherein the SBA comprises an elevated plane function (EPF) configured to directly or indirectly request an in-band registration or out-of-band registration to a modified network resource function (mNRF).

The technical objects, technical features, and effects to be achieved in the disclosure are not limited to the technical objects, technical features, and effects mentioned above, and other technical objects, technical features, and effects not mentioned above may be clearly understood by those skilled in the art from the following descriptions.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to various embodiments;

FIG. 2 illustrates an example of a metaverse architecture according to one embodiment;

FIG. 3 illustrates a network system for providing virtual world services according to an embodiment;

FIGS. 4, 5, and 6 illustrate an example of a Trino architecture according to one embodiment;

FIG. 7 illustrates an example of a fifth generation (5G) system architecture according to one embodiment;

FIG. 8 illustrates an example of a 5G system and multi-access edge computing group (MEC) function according to an embodiment;

FIG. 9 illustrates an example of an MEC application according to one embodiment;

FIG. 10 illustrates an example of 5G system architecture and third-party services according to one embodiment;

FIGS. 11 and 12 illustrate an example of a system for providing a virtual world service and method thereof according to one embodiment;

FIGS. 13 and 14 illustrate an example of a system for providing a virtual world service and method thereof according to one embodiment;

FIGS. 15 and 16 illustrate an example of a system for providing a virtual world service and method thereof according to one embodiment; and

FIGS. 17 and 18 illustrate an example of a system for providing a virtual world service and method thereof according to one embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

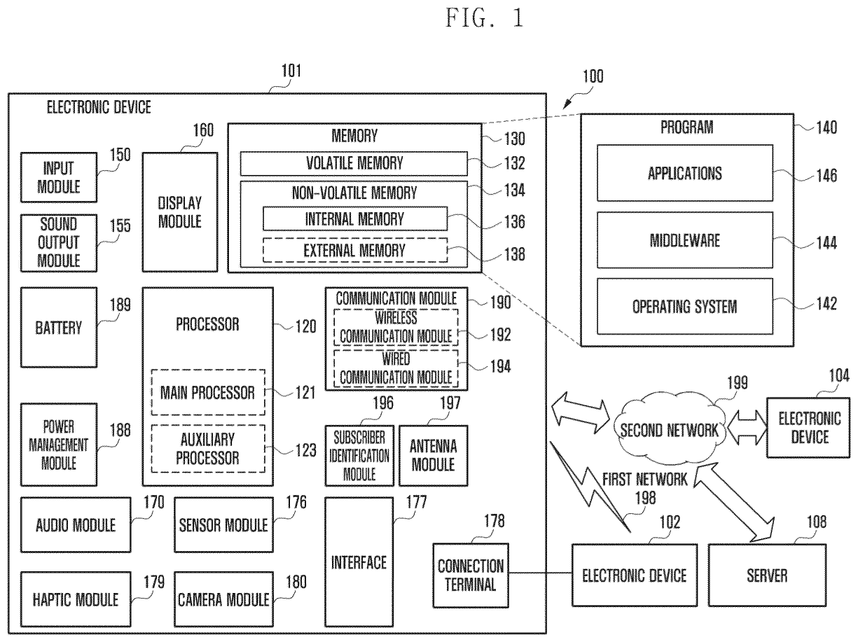

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

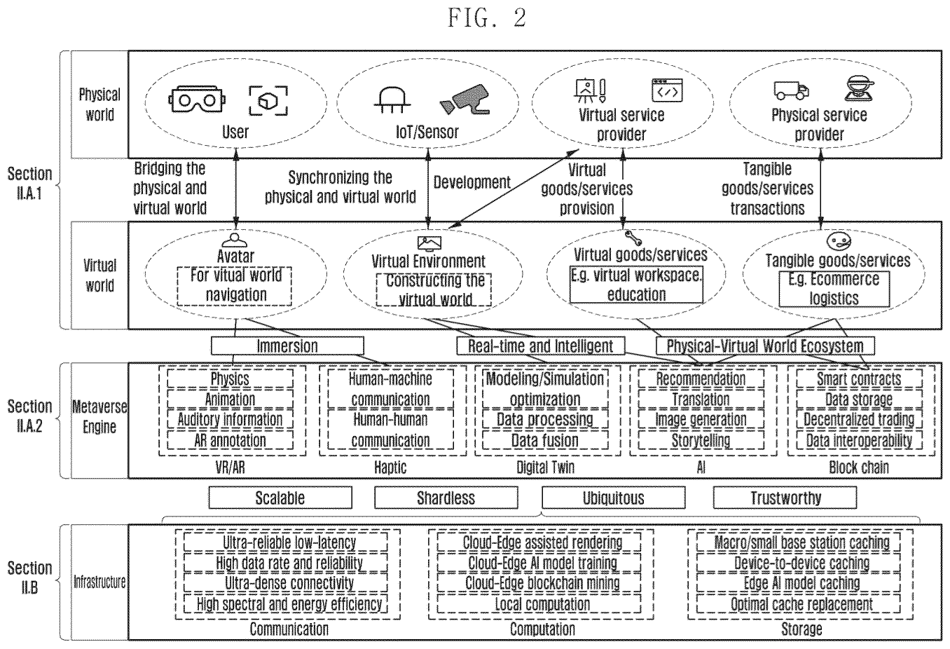

FIG. 2 illustrates an example of a metaverse architecture according to one embodiment.

According to one embodiment, as an example of a virtual world service, a metaverse architecture may include various technologies and systems to provide an environment that fuses the virtual or extended reality world with the physical world. A virtual world exists in parallel with the physical world and may refer to a space where users virtually explore and interact.

Virtual world services may be implemented through various functions, such as a metaverse engine that implements various technologies based on various platforms and infrastructure (e.g., metaverse edge infrastructure) in the physical world. Virtual world services may be implemented, for example, through various virtual products or services provided to avatars that act according to the user's intentions. For example, virtual world services may be implemented by combining various technologies such as virtual reality (VR), augmented reality (AR), blockchain, haptics, digital twin, cloud computing, and artificial intelligence (AI).

In the physical world, users may experience the virtual world through service support from a virtual service provider or a physical service provider through a client application installed on an electronic device (e.g., the electronic device 101 in FIG. 1) such as a smartphone, laptop, or PC and various peripheral devices (e.g., the electronic device 102 in FIG. 1) such as an IoT device including various sensors, a VR headset, or a smart watch.

Virtual reality technology or augmented reality technology (VR/AR) may project virtual objects into the physical world to allow users to experience a virtual world implemented in parallel with the physical world. As virtual elements are added to the physical world, interactivity may increase, and the user's vision and hearing are connected to the virtual world, so the physical world and virtual world are fused, allowing the user to become immersed in the virtual world.

A large-scale metaverse environment requires a lot of computation and storage capacity, and cloud computing may be used to meet these requirements by allowing users to access the metaverse through high-performance servers.

Blockchain technology may be used to protect digital assets and ownership by recording ownership of digital assets and tracking transactions in the virtual world. It may also implement strong security systems and privacy policies to protect user data and privacy in the virtual world.

AI and natural language processing technology may be used to enhance the realism and interactivity of the virtual world by detecting and reacting to the user's motions and voice and enabling conversations with virtual characters.

User interface and experience design in the virtual world may allow users to interact more conveniently in the virtual world through intuitive and user-friendly interfaces and designs.

Metaverse edge infrastructure is an important technology and infrastructure for implementing and supporting the metaverse environment, and may include distributed network technology, latency reduction technology, and content caching and streaming technology.

The metaverse edge infrastructure is based on a distributed network structure, enabling users to access and interact with the metaverse from anywhere in the world, efficiently caches and streams content to minimize latency for real-time interaction and optimizes data flow such as large 3D models, textures, and videos, and utilizes AI technology to interact with users and controls the motions of characters and objects within the virtual world.

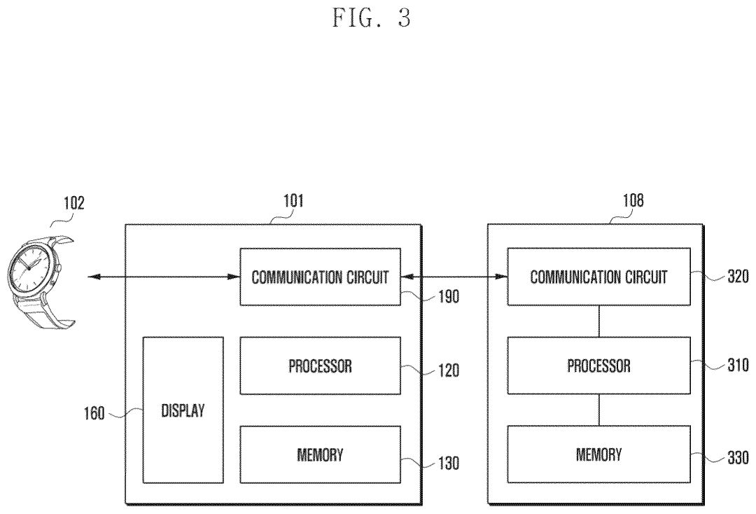

FIG. 3 illustrates a network system for providing virtual world services according to one embodiment. According to one embodiment, a network system includes one or more client electronic devices (e.g., the electronic device 101 in FIG. 1), one or more external electronic devices (e.g., the electronic device 102 in FIG. 1), one or more servers (e.g., the electronic device 108 in FIG. 1), and a network (e.g., the first network 198 or the second network 199 in FIG. 1). Hereinafter, the metaverse will be described as an example of a virtual world, but the embodiments are not limited thereto, and the virtual world may include various virtual worlds composed of various concepts without being limited by name in addition to the metaverse.

According to one embodiment, the electronic device 101 may include a computing device such as a personal computer (PC), laptop, or smart phone. The electronic device 101 may be connected to an external electronic device (e.g., the electronic device 102 in FIG. 1) such as a head-mounted display, a smart watch, or various sensors and may access the server 108 through a network.

According to one embodiment, one or more servers 108 may host a simulated virtual world or metaverse for a plurality of client electronic devices 101.

The electronic device 101 may include a communication circuit (e.g., the communication module 190 in FIG. 1) for communicating with the external electronic device 102 or server 108, a processor (e.g., the processor 120 in FIG. 1), a memory (e.g., the memory 130 in FIG. 1), and a display (e.g., the display module 160 in FIG. 1).

According to one embodiment, the processor 120 may load and execute the metaverse application stored as computer-readable instructions in the memory 130, process the metaverse application command, and store related data packets in the memory 130 according to the execution of the metaverse application, or transmit and receive the related data packets through the communication module 190. The components of the electronic device 101 in FIG. 3 may further include various components illustrated in FIG. 1 as examples.

The metaverse application may include a client program that allows the electronic device 101 to operate as a client of the metaverse service provided by the server 108, for example. Through the client program, the electronic device 101 may enable the user to interact with other users on other client electronic devices connected to the server 108. For example, the client program may include a group link interface that enables a user to control or configure group link connections and interact within the metaverse virtual world as part of the group link connections.

According to one embodiment, the electronic device 101 may display a visual representation of the virtual world in three or four dimensions through various display devices including the display 160.

According to one embodiment, the electronic device 101 may obtain various data from the external electronic device 102, such as a connected head-mounted display, a smart watch, or various sensors. For example, data obtained from the external electronic device 102 may include, for example, data related to respiration, blood pressure, heart rate, and/or body posture and activity measured based on the signals obtained through a biometric sensor and accelerometer sensor (e.g., the sensor module 176 in FIG. 1). For example, a smart watch may obtain various data such as electrocardiogram (ECG), heart rate, blood oxygen level, stress level, and movement data including movement speed and direction, and transmit the same to the electronic device 101.

According to one embodiment, the electronic device 101 may provide the real world data obtained from the external electronic device 102 to the virtual world such as the metaverse through the server 108 and receive data from the virtual world, and thus, synchronize the real world data and virtual world data.

According to one embodiment, the server 108 includes a processor 310 (e.g., the processor 120 in FIG. 1), a communication circuit 320 (e.g., the communication module 190 in FIG. 1), and a memory 330 (e.g. the memory 130 in FIG. 1).

The server 108 may implement a virtual world in which users of one or more electronic devices 101 may participate and interact with each other through the metaverse application stored in the memory 330 as computer-readable instructions. For example, the server 108 may enable various users in a virtual world to interact with each other through objects or avatars representing them or to perform various activities, such as purchasing virtual or physical products or services.

The server 108 may optimize virtual world services by collecting and analyzing data through AI to identify anomalous data, predicting and correcting problems to prevent network performance degradation or interruption. The server 108 may connect with an advertising server to provide advertising services through the virtual world, and search for and provide related advertising campaigns based on user behavior analyzed through AI. For example, the advertising server may provide information including advertising campaign resources and advertising metadata to server 108 to enable real-time interactive advertisements to be presented to the virtual world.

According to one embodiment, the electronic device 101 may transmit and receive and synchronize data from the real world and virtual world to identify cheating attempts in the metaverse virtual world through the server 108, and the server 108 may analyze data to predict problems that may occur in the virtual world in order to avoid problems that may occur or take appropriate responses by an associated resilience engine.

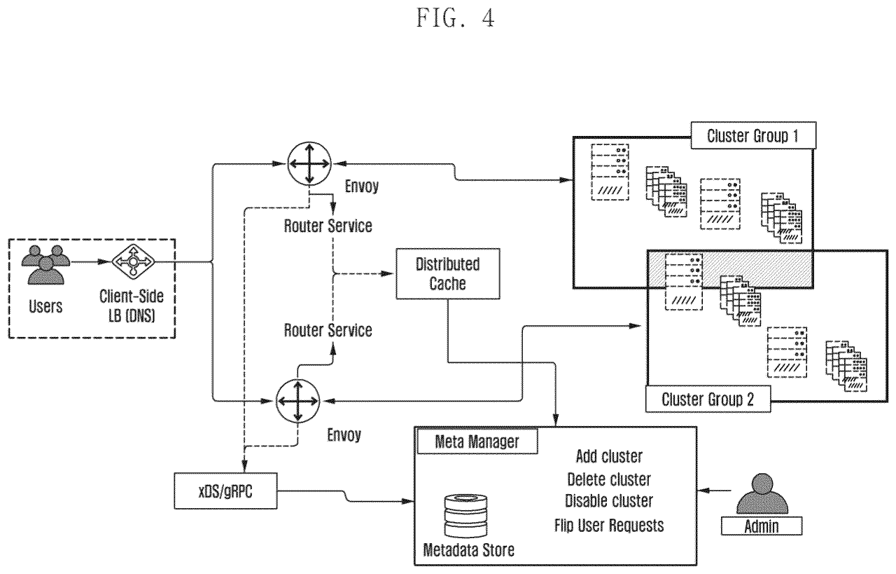

FIGS. 4, 5, and 6 illustrate an example of a Trino architecture according to one embodiment.

With reference to FIG. 4, a Trino architecture may integrate internal authentication, authorization, data catalog, and monitoring systems through a plurality of clusters. The Trino architecture may support data sources through cloud and monitoring systems, and may establish a connection with a hadoop distributed file system (HDFS) through a hive connector.

The user may connect to Trino using a variety of clients, for example, CLI, JupyterHub, SQL editor, custom reporting tools, and JDBC-based apps. When the user issues a query, the query is transmitted to a client-side load balancer (DNS-based load balancer), which may route the query to a subordinate Envoy router. The router may parse the query header to determine the user of the corresponding query and determine which cluster group the query should be routed to, based on the user. When a query reaches a cluster group, the corresponding query may be assigned to one of the subclusters of the corresponding cluster group. For example, when the user executes a query, depending on the routing rules, the query may be routed to cluster group 2 and then rerouted again to one of the subclusters. Envoy is an open source edge and service proxy designed for cloud-native applications, and may provide features such as routing, traffic management, load balancing, external authorization, and rate limiting. The Envoy proxy may be used as a Trino gateway, allowing dynamic routing to be achieved externally without changing Trino's default behavior. The metadata service may provide cluster-related configuration to the Envoy router, including cluster groups, cluster groups and subclusters, and mapping cluster groups to users.

The Envoy control plane is an xDs gRPC-based service. When Envoy starts, it may dynamically retrieve upstream cluster configuration by querying the xDs API and periodically poll the Metadata Service to search for changes in the cluster configuration. The Envoy may provide HTTP filters that may parse and modify both request and response headers, and use a custom Lua filter to parse the request and extract the x-Trino-user header, calling a router service that returns the upstream cluster address.

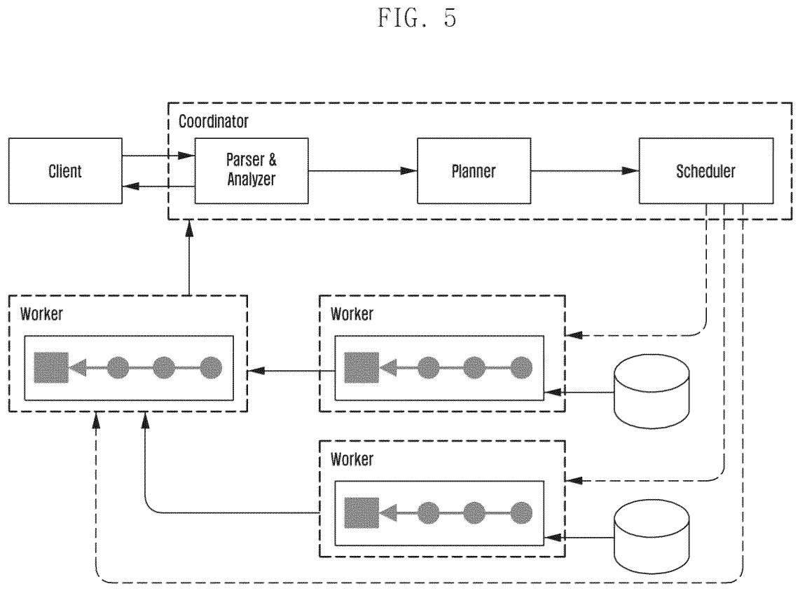

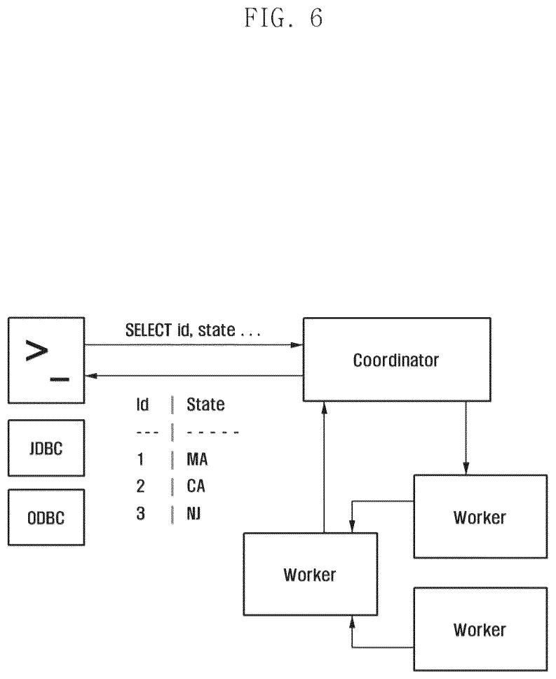

With reference to FIGS. 5 and 6, the Trino is a distributed SQL query engine similar to massively parallel processing (MPP), and may perform distributed processing through a plurality of server clusters in a horizontal manner. By utilizing this Trino architecture, the Trino query engine may process SQL and process SQL queries on large amounts of data in parallel through a computer or node cluster.

A Trino cluster may include one coordinator and a plurality of worker nodes. The Trino user connects to the coordinator through tools such as a JDBC driver or a client using the Trino CLI, and the coordinator may access data sources through workers.

The coordinator is a Trino server that processes incoming queries and manages workers to execute queries, and the worker is a Trino server in charge of task execution and data processing. The coordinator may run a discovery service to register workers to the cluster.

Communication and data transfer between the client, coordinator, and worker may use REST-based interaction over HTTP/HTTPS.

The coordinator may communicate with the worker and client using HTTP-based protocols. Within the cluster, the coordinator may communicate with the worker to assign tasks, update status, and obtain the top-level result set to return to the user. The workers may communicate with other workers to receive data and retrieve result sets from data sources.

The Trino coordinator may receive SQL and perform syntax parsing and analysis (parser and analyzer), query plan (planner), and worker node scheduling (scheduler) on the user's query. The user may interact with the coordinator through Trino CLI, application drivers using JDBC or ODBC, or other client libraries available for a variety of languages. The query statement allows data to be processed by the worker through connected tasks in the cluster, and the processing results may be provided to the coordinator and to the client through an output buffer. Once the output buffer has been read by the client, the coordinator may request more data from the worker on behalf of the client, and the worker may then interact with the data source to retrieve data. The data may continue to be requested by the client until query execution is complete, and may be provided from the data source by the worker.

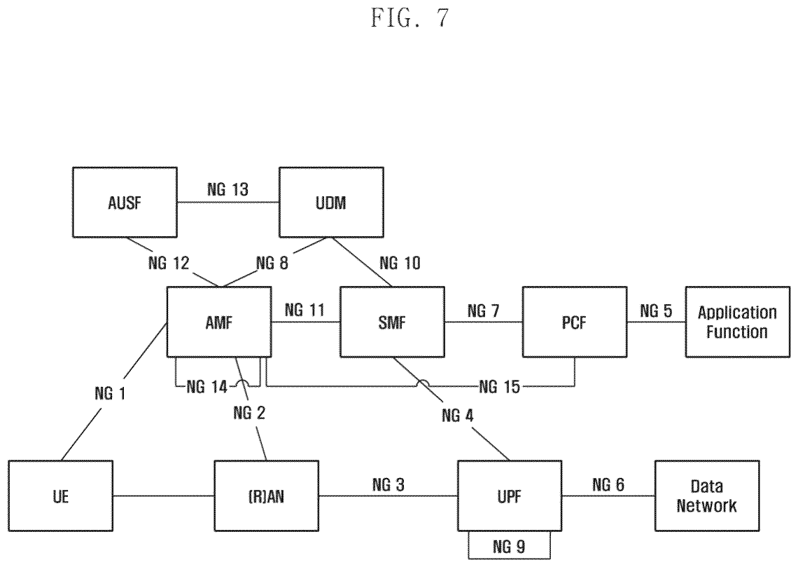

FIG. 7 illustrates an example of a 5G system architecture according to one embodiment.

With reference to FIG. 7, in the 5G system architecture, network functions (NFs) may be implemented as network elements on dedicated hardware, software instances running on dedicated hardware, or virtualized functions instantiated on a platform such as a cloud infrastructure.

An access and mobility management function (AMF), one of the network functions, may provide UE-based authentication, authorization, and mobility management. Since the AMF is independent of access technology, a UE using multiple access technology may basically be connected to a single AMF. A session management function (SMF) is responsible for session management and may assign an IP address to the UE and select and control the user plane function (UPF) for data transmission. In case where the UE has multiple sessions, different SMFs may be assigned to respective sessions to manage them individually and provide different functions for each session. An application function (AF) may provide information about packet flow to a policy control function (PCF), which is responsible for policy control, to support quality of service (QoS). Based on this information, the PCF may determine policies regarding mobility and session management so that the AMF and SMF may operate appropriately. An authentication server function (AUSF) stores data for authentication of the UE, while a user data management (UDM) stores the UE's subscription data. A data network that is not part of the 5G core network may provide internet access or operator services.

The reference point of the 5G system architecture may represent a call flow between NFs. Next generation (NG) 1 may be defined to transmit signaling between UE and AMF. The reference points for connecting between the AN and the AMF and between the AN and the UPF may be defined as NG2 and NG3, respectively. There is no reference point between the AN and the SMF, but NG11, a reference point, may exist between the AMF and the SMF. Therefore, The SMF may be controlled by the AMF. Since NG4 is used by the SMF and UPF, the UPF may be set using the control signal generated by the SMF, and the UPF may report its status to the SMF. NG9 is a reference point for connection between different UPFs, and NG14 is a reference point for connection between different AMFs. NG15 and NG7 may be defined for the PCF to apply policies to the AMF and SMP, respectively. NG12 may be required for the AMF to perform authentication of the UE. NG8 and NG10 may be defined as the UE's subscription data is required for the AMF and SMF.

By separating the control plane and user plane in the 5G system architecture, the user plane may transfer user traffic and the control plane may transfer signals in the network. For example, the UPF is in the user plane, and all other NFs, that is, AMF, SMF, PCF, AF, AUSF, and UDM, are in the control plane. By separating the user plane and control plane, the size of each plane resource may be controlled independently. In addition, the UPF may be deployed separately from the control plane functions in a distributed manner. The UPF may be deployed close to the UE to shorten the round trip time (RTT) between the UE and the data network for some applications that require low latency.

A 5G system architecture may include modular functions. For example, the AMF and SMF are independent functions in the control plane, so separate the AMF and SMF may be capable of independent evolution and expansion. Through modularized functional design, the 5G system architecture may flexibly support a variety of services.

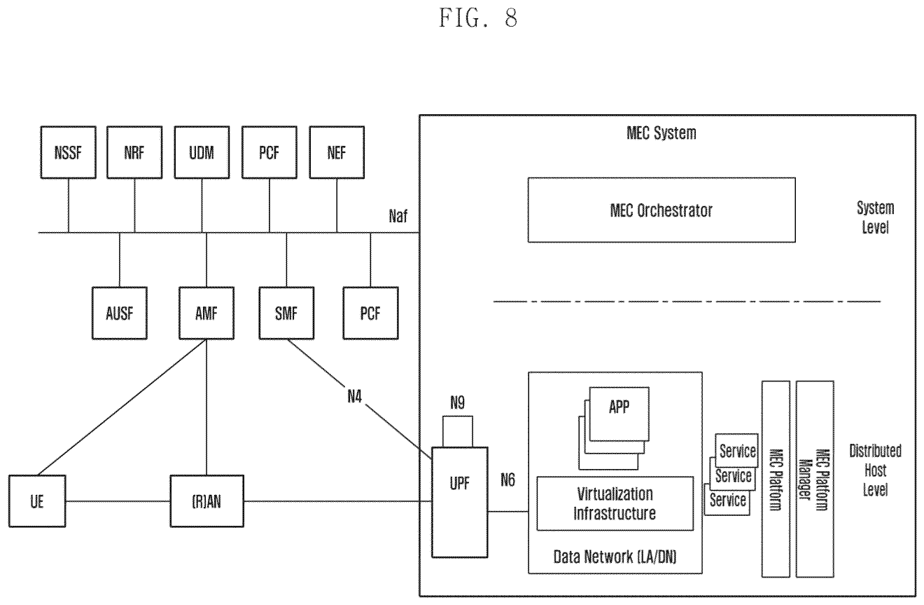

FIG. 8 illustrates an example of a 5G system and multi-access edge computing group (MEC) function according to one embodiment.

Edge computing is an evolution of cloud computing that moves application hosting from centralized data centers to the edge of the network, bringing it closer to the data generated by individual users and applications. The edge computing may support communications networks transforming into versatile service platforms with low latency and increased bandwidth efficiency.

The MEC may be deployed in 5G to connect with the user plane, and may enable interactions with the data plane, from application service management and orchestration to coordinating specific traffic flows.

The 5G system architecture and the 5G system architecture defined by MEC 3GPP are designed to support a variety of use cases, from large numbers of IoT devices to high-bandwidth and high-reliability mission-critical services. There are two options for 5G system architecture: one that uses a reference point and an interface approach scheme, and another where core network functions interact with each other using a service based architecture (SBA).

According to the SBA, there are functions that use services and functions that create services, and network functions may provide one or more services. The SBA may authenticate users, approve service requests, and provide registration, service discovery, availability notification, deregistration, authentication, and approval functions required to provide services efficiently.

With reference to FIG. 8, the 3GPP 5G system on the left and its SBA may be integrated and deployed with the MEC system architecture on the right. Entities in the MEC may interact with network functions (NF) of the 5G core network.

Network functions and the services they create are registered in a network resource function (NRF), and services created in MEC applications may be registered in the service registry of the MEC platform. Service registration is part of the application activation function and enables network functions to directly interact with network functions to create services in case of being authorized to use the service. A list of available services may be found in the NRF, some services may only be accessed via the network exposure function (NEF), and the NEF may make services accessible even to untrusted entities outside the domain. The NEF serves as a central point of service exposure and may play a key role in approving all access requests originating from outside the system.

In 5G, through network slicing, necessary functions and resources from available network functions may be allocated to different services or tenants using the services. The network slice selection function (NSSF) may select an appropriate network slice instance for the user and assign the required access management function (AMF). MEC applications, that is, applications hosted in the distributed cloud of the MEC system, may be included in one or more network slices configured in the 5G core network.

The policies and rules of the 5G system may be processed in the policy control function (PCF). The PCF is the function responsible for services requested by the AF (e.g., MEC platform) to affect traffic streaming rules. The PCF may be accessed directly or through the NEF, and may vary depending on whether the AF is reliable and, in the case of streaming traffic, whether the corresponding PDU session is known at the time of the request.

The unified data management (UDM) function is responsible for various services related to users and subscribers, and may generate 3GPP AKA authentication credentials, process information related to user identification, authorize access (e.g., roaming restrictions), register user service NF (serving AMF, SMF), supports service continuity by recording SMF/DNN (data network naming) allocation details, and perform subscriber management procedures by acting as a point of contact to support legal interception (LI) procedures in external roaming.

The user plane function (UPF) may play a key role in integrated MEC deployments in 5G networks. From the MEC system perspective, the UPF may be viewed as a distributed and configurable data plane, and control of the data plane, i.e., traffic rule configuration, may follow the NEF-PCF-SMF path. Therefore, in certain deployments, a local UPF may be implemented as part of the MEC implementation.

In the right MEC system in FIG. 8, the MEC orchestrator is a functional entity at the MEC system level and operates as an AF, and may interact with target 5G NFs through a network exposure function (NEF) or directly. At the MEC host level, the MEC platform may interact with 5G NFs in the role of AF. The MEC host, i.e., host-level functional entity, is mostly deployed in the data network of 5G systems, the NEF is a core network function, centrally deployed with similar NFs as system-level entities, but instances of NEFs may also be deployed at the edge to permit low-latency and high-throughput service access from the MEC host.

The user movement management is an important function in mobile communication systems. In the 5G system, through an access and mobility management function (AMF), which handles mobility-related procedures, the RAN control plane and non-access stratum (NAS) procedures may be terminated and signal integrity may be protected. The 5G system may host registration, connection and accessibility management, interface with legitimate interception functions for access and movement events, authentication and authorization at the access layer, and security anchor function (SEAF). Through the SBA, the AMF may provide communication and accessibility services to other NFs and also permit subscriptions to receive notifications about movement events.

A session management function (SMF) may perform procedures such as session management, IP address allocation and management, dynamic host configuration protocol (DHCP) services, selection/reselection and control of UPF, configuration of traffic rules of UPF, lawful interception of session management events, billing and roaming support. Since the MEC service may be provided from central and edge clouds, the SMF is responsible for selecting and controlling UPFs, and configuring rules for traffic streaming, and may perform services required to manage PDU sessions, control policy settings and traffic rules, and subscribe to notifications of session management events.

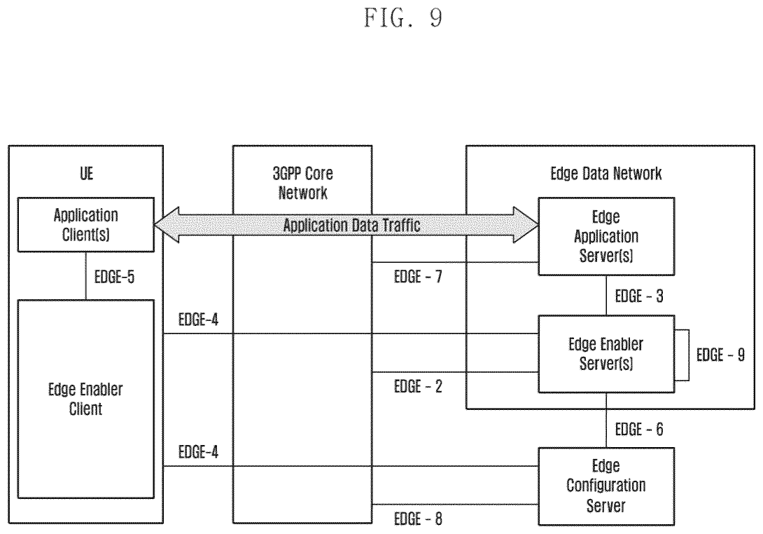

FIG. 9 illustrates an example of an MEC application according to one embodiment.

With reference to FIG. 9, the 3GPP core network may define a functional layer that relays communications for edge computing. This functional layer may relay communication between an application client (AC) or app running on a user equipment (UE) and an edge application server (EAS) deployed on the MEC data network.

A functional layer may facilitates communication between the application clients (ACs) running on the UE and the edge application servers (EASs) deployed on the edge data network. The functional layer may include functions related to service provisioning and EAS discovery, and may provide support services such as application context transfer between EASs for service persistence and service activation for EASs and function exposure APIs.

An application architecture to enable the edge application may include the following elements: an edge enabler client (EEC) provides support functions such as EAS discovery to ACs and may provide support functions to ACs within the UE. An edge configuration server (ECS) may provide configuration information for EEC to connect with EAS.

The UE's application clients may be Edge-aware and Edge-unaware. In case of Edge-aware application, ACs may interact directly with EEC to take full advantage of a SA6 architecture. In the case of Edge-unaware application, the SA6 architecture may provide significant benefits by replacing ACs without direct participation of ACs. The SA2 is working on Edge application support solutions (e.g., using DNS for IP routing to EAS) and may be deployed independently or in conjunction with the SA6 architecture.

With the support of a support layer, the 3GPP network may provide native support for several Edge features, as followings. For example, the 3GPP network may support query filters to permit on-demand service provisioning by the ECS and rich discovery of the EAS by the AC over the EEC. Due to the flexible nature and availability of Edge network, EAS functionality may be subject to change for various reasons, such as changes in deployment or movement of the UE. The UE may subscribe to these dynamic changes to coordinate the services provided to the AC. The EAS may utilize service APIs exposed by the EES, and these APIs is built on the capability of the SCEF/NEF northbound API and may be used in conjunction with the CAPIF framework or independently. This enables EAS to access the 3GPP network capability exposure feature. Due to the movement of the UE, the serving edge or cloud may change or become more suitable for serving the AC.

3GPP mobile networks may interwork with various heterogeneous networks, such as untrusted WLANs. The UE may be provided with access from unauthenticated WLAN to the 4G/5G or 3GPP network through wireless access gateway (WAG) and packet data gateway (PDG). PDG may include tunnel termination gateway (TTG) functionality. The UE accessing 5GCN via unauthenticated WLAN must support NAS signaling, and may operate similarly to 3GPP access that uses AMF to register the UE in the registration and authentication procedures and uses EAP-AKA/5G-AKA authentication using AUSF. Before the registration procedure terminates, an IPsec security association (SA) may be established between the UE and PDG to secure NAS mobility and session management messages. The UE may establish a PDU session using the NAS session management messages and IPsec signaling SA through the SMF and AMF. The UL and DL data packet transmission between the UE and the data network may use an IPsec tunnel between the UE and PDG.

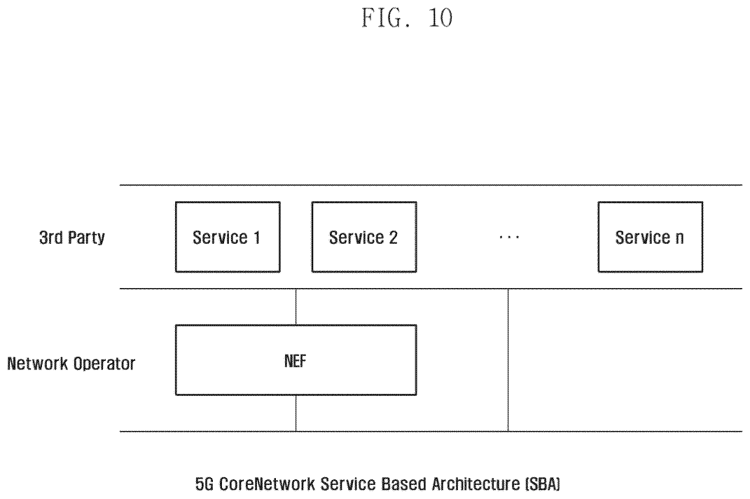

FIG. 10 illustrates an example of 5G system architecture and third-party services according to one embodiment.

In FIG. 10, one or more of the third-party services may be provided by an external entity, for example, an external server, and the external entity providing the third-party service is directly or indirectly connected to the 5G system architecture, and thus, may use the network functions provided by 5G SBA.

In the disclosure, a virtual world service is described as an example of a service provided, but services provided by the external entity or within the 5G system architecture are not limited thereto. The services provided within the 5G system architecture or by external entity may include a variety of services, such as virtual world services that require high-speed 5G communication, game services, broadcast relay services, or services that require low-latency, highly reliable communication (mission critical service).

In the 5G system architecture, a 5G connection network may be used for services provided by the external entity.

5G SBA may permit exposure of functionality to the external entity, for example using the RESTful design of application programming interface (API). The external entity may include a third party, such as a service provider and an industry outside the operator's domain, for example. To enable the external entity to use 5G core network functions, the external entity may connect to the 5G SBA, for example through a network exposure function (NEF), or communicate directly without the NEF so that it may connect to the expanded concept of SBA's services through direct communication without the NEF.

In 3GPP, 5G service exposure by the NEF may be performed based on RESTful API, but is not limited thereto.

Hereinafter, a system for providing various services based on 5G or beyond 5G (B5G), SBA, and MEC, and a method for performing services by the system will be described.

A system for providing a service according to one embodiment may include an electronic device (e.g., the electronic device 101 in FIG. 1 or 3) connected to an external electronic device (e.g., the electronic device 102 in FIG. 1 or 3) and a server (e.g., the server 108 in FIGS. 1 and 3) connected to the electronic device 101.

The 5G control plane (CP) may function within the constraints of SBA, and thus in 6G implementations, the functionality of SBA may be extended to permit CP signaling out-of-frame deployment on both the core and RAN sides.

According to one embodiment, additional flexibility may be introduced, enabling the integration of 3GPP native components such as MEC as well as non-3GPP native components such as cloud or data lake orchestration, in particular by Trino. In particular, the core part, as well as the RAN domain where devices may integrate CP extensions, may also be important.

According to one embodiment, the SBA's NEF may be used outside the SBA to call the SBA's specific NF inside the SBA, rather than communicating with the 3GPP AF.

According to one embodiment, the SBA's specific NF call may be performed within the SBA, and the NEF may be used only for communication purposes, such as interacting with AF.

According to one embodiment, the SBA may be extended to use the SBA's services by communicating directly without the NEF from outside the SBA, for example, using the wireless link of a mobile network operator (MNO) on the RAN side.

According to one embodiment, a system for providing a service may perform various functions or operations through various NFs to provide services based on 5G or beyond 5G (B5G) and SBA and MEC architecture.

According to one embodiment, B5G SBA may be modified and combined with the MEC to enable control plane expansion on the MEC and RAN.

According to one embodiment, a data extraction function (DEF) is used by introducing an elevated plane function (EPF) in the B5G SBA, but the SBA's specific NF may be called from outside the SBA without communicating with the NEF and 3GPP AF.

According to one embodiment, the call by the EPF may occur within the SBA, where the NEF is used for communication purposes only and may interact with the AF to access the MV.

According to one embodiment, a virtual mesh function (VMF) is permitted on the RAN side, and the MNO's wireless link may be used to extend the SBA through direct communication through the EPF without the NEF.

According to one embodiment, the EPF may cause the SBA's specific NF to be called from outside the SBA. DEF may permit MV data extraction through the MV of the interconnected cloud. MTV may permit automated parameter acquisition from the interconnected MTV. The MTV may be a function defined in the cloud for communication between MV and DEF. A modified user data management (mUDM) may perform registration of a tandem including the UE and a corresponding AV. A modified access and mobility management function (mAMF) may retrieve the parameters of the UE and enable authentication of the AV. A modified network exposure function (mNEF) may perform internal exposure and parameter retrieval. A modified network resource function (mNRF) may permit registration of an external AF in the SBA.

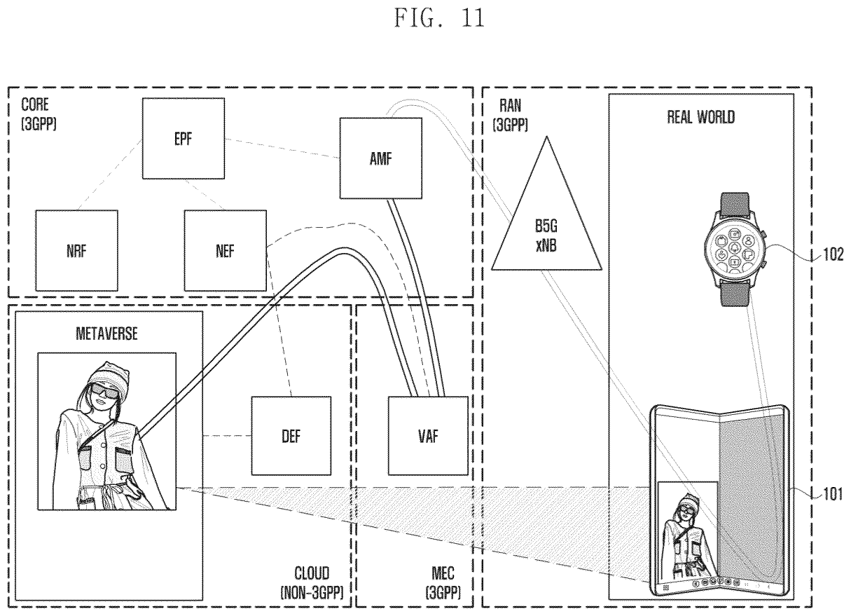

Hereinafter, with reference to FIGS. 11 to 18, a system for providing various services based on 5G or beyond 5G (B5G), SBA, and MEC, and a method of performing services by the system will be described. A method for providing various services, for example, a virtual world service is described as an example, but the embodiments are not limited thereto, and the disclosed embodiments may be applied to a method for providing a service provided by the external entity as described above, directly or indirectly, in conjunction with at least part of the functions provided by 5G or beyond 5G (B5G), SBA and MEC.

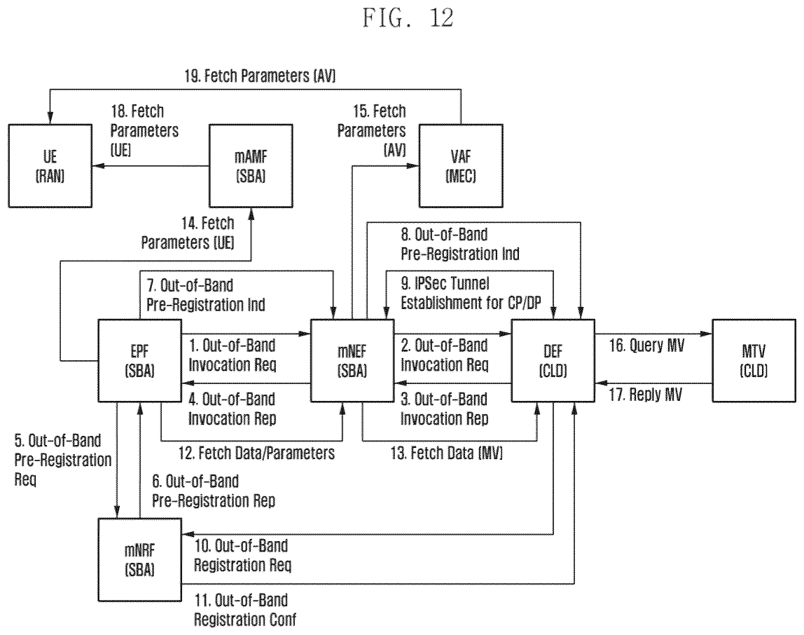

FIGS. 11 and 12 illustrate an example of a method for providing a virtual world service according to one embodiment.

According to one embodiment, various operations may be performed by applying the EPF within the SBA. For example, an out-of-band call of DEF may be performed through the mNEF. IPSec tunnel establishment for CP/DP may be performed. The out-of-band registration of DEF for the mNRF may be performed.

According to one embodiment, various operations may be triggered by calling the EPF within the SBA. For example, the data and parameter retrieval process may be triggered by making relevant requests directly to the mAMF. Relevant requests may be made to the DEF via the mNEF to trigger the data and parameter retrieval process. Through the mNEF, relevant requests may be made to Virtual A (VAF) to trigger the data and parameter retrieval process.

According to one embodiment, various operations may be performed by triggering DEF outside of SBA. For example, CLD may request data inquiry from MTV. The CLD may obtain data response from the MTV.

According to one embodiment, various operations may be performed by triggering the MEC's specific virtual avatar function (VAF) from outside the SBA. For example, AV parameters may be obtained from the UE. The above-described operations may be performed through B5G xNB.

In addition, the SBA's specific AMF may be triggered to perform the following operations. For example, UE parameters may be obtained from the UE. The above-described operations may be performed through B5G xNB.

With reference to FIG. 12, an out-of-band call request from the SBA's EPF may be transmitted to the DEF through the SBA's mNEF, and the DEF may transmit a response to the out-of-band call request to the EPF through the mNEF. The EPF may transmit an out-of-band pre-registration request to the mNRF and receive a response thereto. The EPF may notify DEF of the out-of-band pre-registration through the mNEF. Accordingly, the DEF may establish an IPsec tunnel for CP/DP and request an out-of-band registration from the mNRF. The DEF may receive out-of-band registration confirmation from the mNRF. The mNEF may obtain data and parameters from the EPF and AV parameters from the VAF, and transfer the obtained MV data to the DEF. The EPF may obtain the UE's parameters from the mAMF, and the mAMF may obtain the UE's parameters from the UE. The VAF may obtain AV parameters from the UE. The DEF may transfer MV queries to the MTV and receive MV responses.

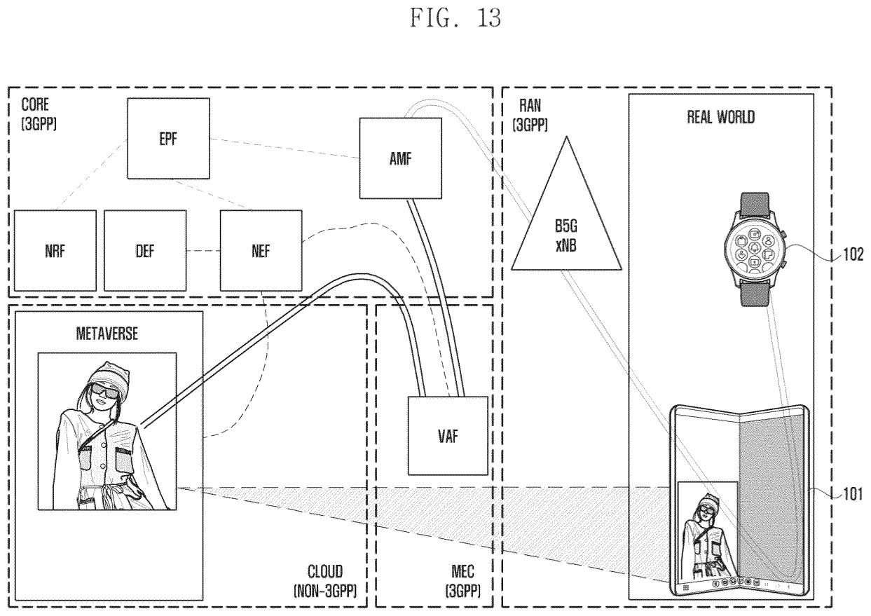

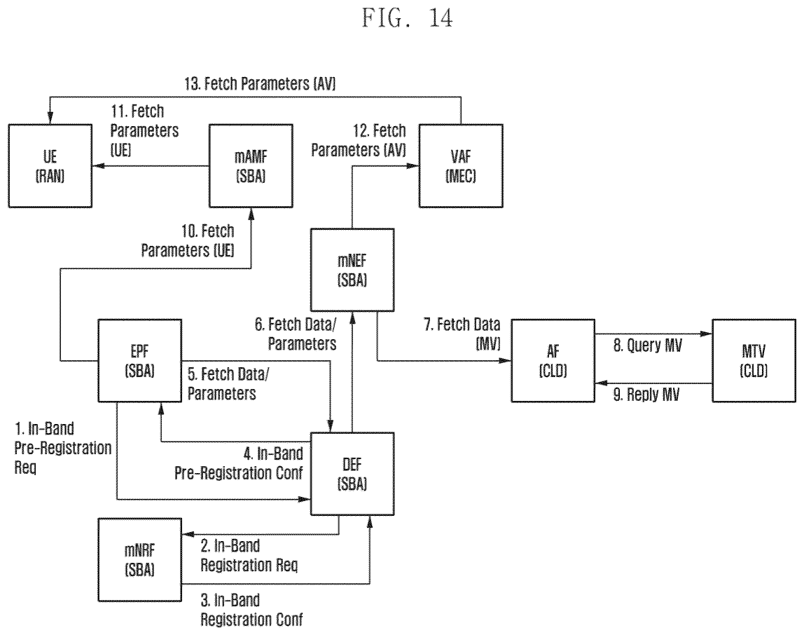

FIGS. 13 and 14 illustrate an example of a method for providing a virtual world service according to one embodiment.

According to one embodiment, various operations may be performed by applying the EPF within the SBA. For example, an out-of-band call of DEF may be performed through the mNEF. An IPSec tunnel establishment may be performed for CP/DP. In-band registration of DEF for the mNRF may be performed.

According to one embodiment, various operations may be triggered by calling the EPF within the SBA. For example, the data and parameter retrieval process may be triggered by making relevant requests directly to the mAMF. Through the mNEF, it is possible to trigger the data and parameter retrieval process from the DEF to the AF. Through the mNEF, relevant requests may be made from the DEF to the VAF to trigger the data and parameter retrieval process.

According to one embodiment, various operations may be performed by triggering the DEF from outside the SBA. For example, the CLD may request data inquiry from the MTV. The CLD may obtain data response from the MTV.

According to one embodiment, various operations may be performed by triggering the MEC's specific VAF from outside the SBA. For example, AV parameters may be obtained from the UE. The above-described operations may be performed through B5G xNB. For example, by receiving a service request from an external entity, information about the external entity may be obtained.

In addition, the SBA's specific AMF may be triggered to perform the following operations. For example, UE parameters may be obtained from the UE. The above-described operations may be performed through B5G xNB.

With reference to FIG. 14, an in-band call request from the SBA's EPF may be directly transmitted to the DEF. The DEF may request an in-band registration from the mNRF according to the in-band call request, receive the registration confirmation, and then transmit the in-band registration confirmation to the EPF. The EPF may request acquisition of data and/or parameters from the DEF, and the DEF may request acquisition of data and/or parameters from the mNEF to request MV data from the AF in the cloud. The AF may receive an MV response by transmitting an MV query to the MTV in the cloud. The EPF may request UE parameters from the mAMF, and the mAMF may request UE parameters from the UE. The mNEF may request AV parameters from the VAF, and the VAF may request AV parameters from the UE.

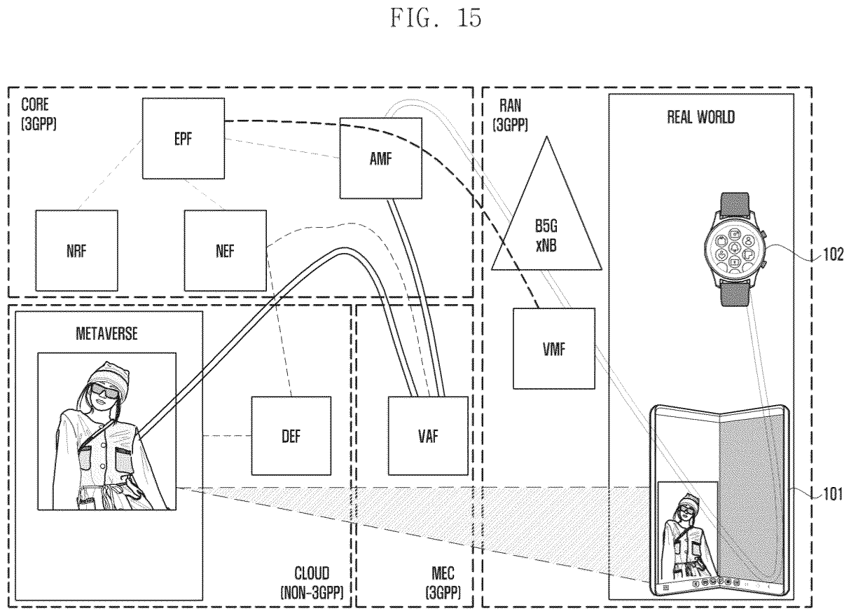

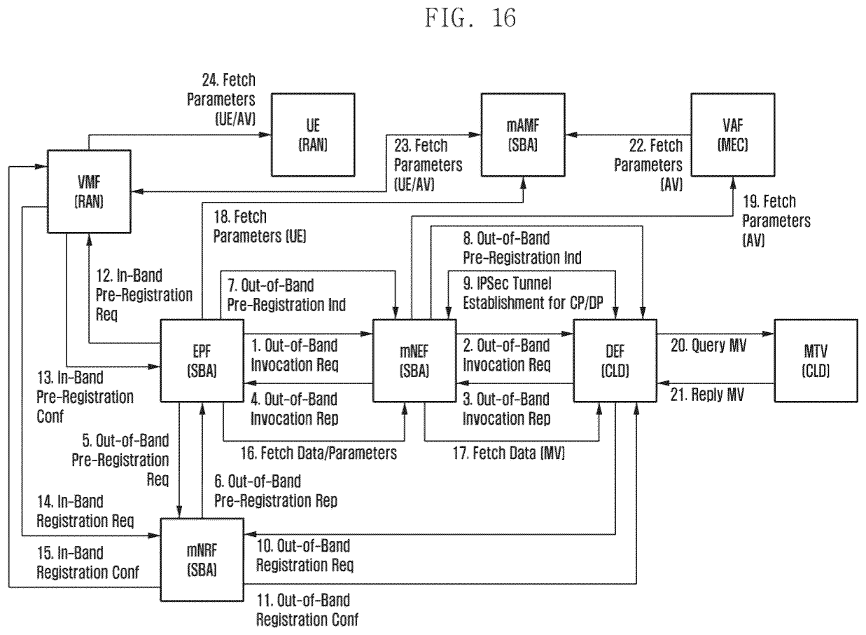

FIGS. 15 and 16 illustrate an example of a method for providing a virtual world service according to one embodiment.

According to one embodiment, various operations may be performed by applying the EPF within the SBA. For example, an out-of-band call of DEF may be performed through the mNEF. An IPSec tunnel establishment may be performed for CP/DP. The out-of-band registration of DEF for the mNRF may be performed. The in-band registration of the SBA's VMF may be performed.

According to one embodiment, various operations may be triggered by calling the EPF within the SBA. For example, the data and parameter retrieval process may be triggered by making relevant requests directly to the mAMF. Relevant requests may be made to the DEF through the mNEF to trigger the data and parameter retrieval process. Relevant requests may be made to the VAF through the mNEF to trigger the data and parameter retrieval process.

According to one embodiment, various operations may be performed by triggering the DEF from outside the SBA. For example, the CLD may request a data inquiry from the MTV. The CLD may obtain a data response from the MTV.

According to one embodiment, various operations may be performed by triggering the MEC's specific VAF from outside the SBA. For example, AV parameters may be obtained from the VMF through the mAMF. The above-described operations may be performed through B5G xNB.

In addition, the SBA's specific AMF may be triggered to perform the following actions. For example, UE parameters may be obtained from the VMF through the mAMF. The above-described operations may be performed through B5G xNB.

With reference to FIG. 16, an out-of-band call request from the SBA's EPF may be transmitted to the DEF through the SBA's mNEF, and the DEF may transmit a response to the out-of-band call request to the EPF through the mNEF. The EPF may transmit an out-of-band pre-registration request to the mNRF and receive a response thereto. The EPF may notify the DEF of out-of-band pre-registration through the mNEF. Accordingly, the DEF may establish an IPsec tunnel for CP/DP and request an out-of-band registration from the mNRF. The DEF may receive an out-of-band registration confirmation from the mNRF. The EPF may request an in-band pre-registration from the VMF and receive an in-band pre-registration confirmation. The VMF may transmit an in-band registration request to the mNRF and receive an in-band registration confirmation. The EPF may request data and/or parameter acquisition from the mNEF, and the mNEF may request MV data from the DEF. The EPF may request acquisition of UE parameters from the mAMF. The mNEF may request AV parameters through the VAF, and the VAF may request AV parameters through the mAMF. The mAMF may obtain parameters of the UE and AV from the UE through the VMF. The DEF may transmit an MV query to the MTV and receive an MV response.

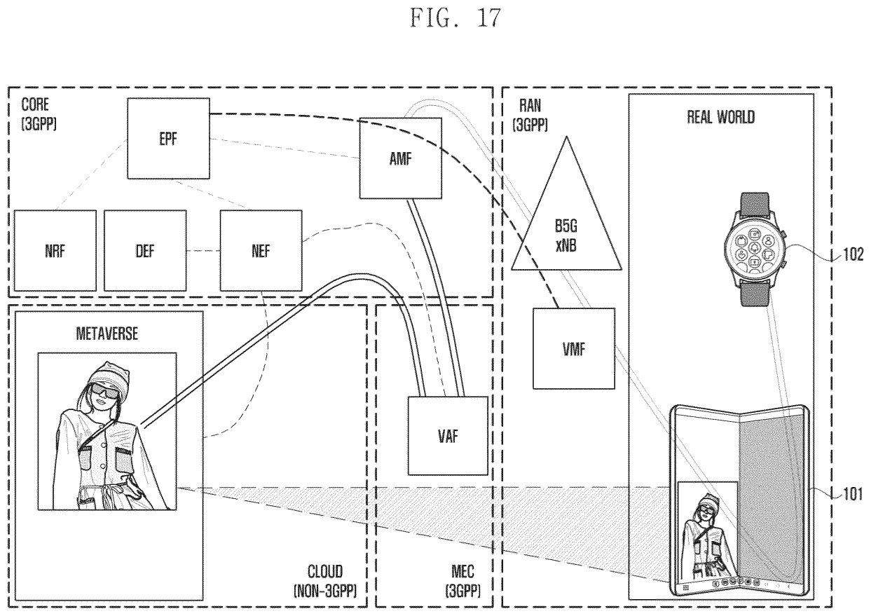

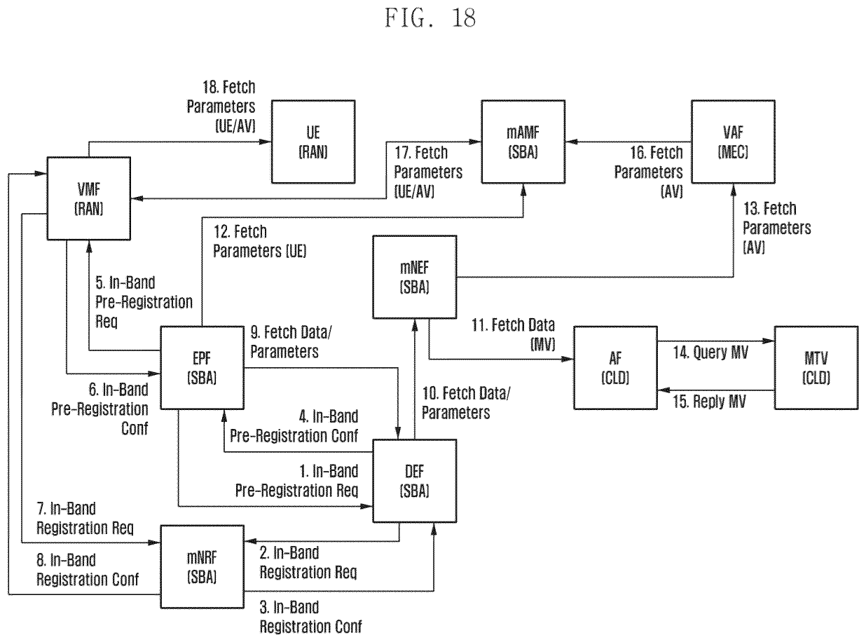

FIGS. 17 and 18 illustrate an example of a method for providing a virtual world service according to one embodiment.

According to one embodiment, various operations may be performed by applying the EPF within the SBA. For example, an out-of-band call of DEF may be performed through the mNEF. An IPSec tunnel establishment may be performed for CP/DP. An in-band registration of DEF for the mNRF may be performed.

According to one embodiment, various operations may be triggered by calling the EPF within the SBA. For example, the data and parameter retrieval process may be triggered by making relevant requests directly to the mAMF. Through the mNEF it is possible to trigger the data and parameter retrieval process from the DEF to the AF. Through the mNEF, relevant requests may be made from the DEF to the VAF to trigger the data and parameter retrieval process.

According to one embodiment, various operations may be performed by triggering the DEF from outside the SBA. For example, the CLD may request a data inquiry from the MTV. The CLD may obtain a data response from the MTV.

According to one embodiment, various operations may be performed by triggering the MEC's specific VAF from outside the SBA. For example, AV parameters may be obtained from the UE. The above-described operations may be performed through B5G xNB. For example, by receiving a service request from an external entity, information about the external entity may be obtained.

In addition, the SBA's specific AMF may be triggered to perform the following actions. For example, UE parameters may be obtained from the VMF through the mAMF. The above-described operations may be performed through B5G xNB.

With reference to FIG. 18, an in-band call request from the SBA's EPF may be directly transmitted to the DEF. The DEF may request an in-band registration from the mNRF according to the in-band call request, receive the registration confirmation, and then transmit the in-band registration confirmation to the EPF. The EPF may request an in-band pre-registration from the VMF and receive an in-band pre-registration confirmation. The VMF may transmit an in-band registration request to the mNRF and receive an in-band registration confirmation. The EPF may request data and/or parameter acquisition from the DEF, the DEF may request data and/or parameters from the mNEF, the mNEF may request MV data from the AF, and AV parameters may be requested from the VAF. The AF may transmit an MV query to the MTV and receive an MV response. The VAF may request AV parameters through the mAMF. The mAMF may obtain parameters of the UE and AV from the UE through the VMF.

According to one embodiment, the method for providing a service may include receiving a service request from an external entity in a service based architecture (SBA), requesting an in-band registration or out-of-band registration for the external entity to a modified network resource function (mNRF) directly or indirectly by an elevated plane function (EPF) of the SBA, and providing at least a part of the service function of the SBA to the external entity based on the registration.

According to one embodiment, the method for providing a service may include a method for providing a virtual world service. For example, the method for providing a virtual world service may include requesting an in-band registration or out-of-band registration to the modified network resource function (mNRF) directly or indirectly by the elevated plane function (EPF) of the service based architecture (SBA), obtaining, by the EPF, parameters for a user equipment (UE) and a virtual object representing the UE in the virtual world from the UE through a modified access and mobility management function (mAMF) or a virtual avatar function (VAF), and transmitting, by the EPF, the parameters for the UE and virtual object to a data extraction function (DEF) or application function (AF) and requesting and receiving information related to the virtual world.

According to one embodiment, the method may further include requesting the out-of-band call to the DEF directly or indirectly by the EPF.

According to one embodiment, the EPF may transmit the out-of-band call to the EDF through the modified network exposure function (mNEF).

According to one embodiment, the EPF may transmit the registration request to the mNRF through the DEF.

According to one embodiment, the method may further include transmitting, by the EPF, an in-band registration or out-of-band pre-registration request to the mNRF through a virtual mesh function (VMF).

According to one embodiment, the method may further include requesting, by the EPF, the parameters for the virtual object from a virtual application function (VAF) through a modified network exposure function (mNEF).

According to one embodiment, the method may further include requesting, by the VAF, the parameter for the virtual object through the mAMF.

According to one embodiment, the EPF may transmit the parameters for the UE and virtual object to the DEF or AF through a modified network exposure function (mNEF).

According to one embodiment, the method may further include directly transmitting, by the EPF, an out-of-band pre-registration request to the mNRF, and indirectly transmitting, by the EPF, an in-band pre-registration request to the mNRF through a virtual mesh function (VMF).

According to one embodiment, the method may further include requesting, by the EPF, the parameter for the UE from the mAMF, and transmitting, by the EPF, a parameter request for the virtual object to the mAMF through the VAF.

According to one embodiment, a system for providing a service may include a service based architecture (SBA) that receives a service request from an external entity, and the SBA may include an elevated plane function (EPF) of the SBA that directly or indirectly requests an in-band registration or out-of-band registration to a modified network resource function (mNRF).

According to one embodiment, the system for providing a service may include a system for providing a virtual world service. The system for providing a virtual world service may include an elevated plane function (EPF) of a service based architecture (SBA) that directly or indirectly requests an in-band registration or out-of-band registration to a modified network resource function (mNRF), a modified access and mobility management function (mAMF) that obtains parameters for a user equipment (UE) and virtual object representing the UE in the virtual world from the UE according to the request of the EPF, and a data extraction function (DEF) that receives the parameters for the UE and virtual object from the EPF and requests and receives information related to the virtual world.

According to one embodiment, the EPF may directly or indirectly request an out-of-band call to the DEF.

According to one embodiment, the system may further include a modified network exposure function (mNEF) that transmits the out-of-band call from the EPF to the EDF.

According to one embodiment, the EPF may transmit the registration request to the mNRF through the DEF.

According to one embodiment, the system may further include a virtual mesh function (VMF) that transmits an in-band registration or out-of-band pre-registration request from the EPF to the mNRF.

According to one embodiment, the system may further include a modified network exposure function (mNEF) that receives the parameter request for the virtual object from the EPF and transmits the parameter request to a virtual application function (VAF).

According to one embodiment, the VAF may request the parameter for the virtual object through the mAMF.

According to one embodiment, the EPF may further include a modified network exposure function (mNEF) that transmits the parameters for the UE and virtual object to the DEF or AF.

According to one embodiment, the EPF may directly transmit an out-of-band pre-registration request to the mNRF, and the EPF may indirectly transmit an in-band pre-registration request to the mNRF through a virtual mesh function (VMF).

According to one embodiment, the EPF may request the parameter for the UE to the mAMF, and the EPF may transmit a parameter request for the virtual object to the mAMF through the VAF.

The embodiments disclosed in the disclosure are merely presented as examples to easily explain the technical content and aid understanding, and are not intended to limit the scope of the technology disclosed in the disclosure. Therefore, the scope of the technology disclosed in the disclosure should be interpreted as including all changes or modified forms derived based on the technical idea of the various embodiments disclosed in the disclosure, in addition to the embodiments disclosed herein.

What is claimed is:

1. A method for providing a service, the method comprising:
receiving a service request from an external entity in a service based architecture (SBA);
requesting, by an elevated plane function (EPF) of the SBA, an in-band registration or out-of-band registration for the external entity to a modified network resource function (mNRF) directly or indirectly; and
based on the in-band registration or the out-of-band registration, providing at least a part of service function of the SBA to the external entity.

2. The method of claim 1, further comprising requesting, by the EPF, an out-of-band call to a data extraction function (DEF) directly or indirectly.

3. The method of claim 2, wherein the EPF is configured to transmit the out-of-band call to the EDF through a modified network exposure function (mNEF).

4. The method of claim 1, wherein the EPF is configured to transmit a request for the in-band registration or a request for the out-of-band registration to the mNRF through a data extraction function (DEF).

5. The method of claim 1, further comprising transmitting, by the EPF, an in-band pre-registration request or an out-of-band pre-registration request to the mNRF through a virtual mesh function (VMF).

6. The method of claim 1, further comprising requesting, by the EPF, information about the external entity to a virtual application function (VAF) through a modified network exposure function (mNEF).

7. The method of claim 6, further comprising requesting, by the VAF, the information about the external entity through a modified access and mobility management function (mAMF).

8. The method of claim 1, wherein the EPF is configured to transmit information about the external entity to a data extraction function (DEF) or application function (AF) through a modified network exposure function (mNEF).

9. The method of claim 1, further comprising:
directly transmitting, by the EPF, an out-of-band pre-registration request to the mNRF; and
indirectly transmitting, by the EPF, an in-band pre-registration request to the mNRF through a virtual mesh function (VMF).

10. The method of claim 1, further comprising:
requesting, by the EPF, information about the external entity to a modified access and mobility management function (mAMF); and
transmitting, by the EPF, an information request about the external entity to the mAMF through a virtual avatar function (VAF).

11. A system for providing a service, the system comprising a service based architecture (SBA) configured to receive a service request from an external entity,
wherein the SBA comprises an elevated plane function (EPF) configured to directly or indirectly request an in-band registration or out-of-band registration to a modified network resource function (mNRF).

12. The system of claim 11, wherein the EPF is configured to directly or indirectly request an out-of-band call to the DEF.

13. The system of claim 12, further comprising a modified network exposure function (mNEF) configured to transmit the out-of-band call from the EPF to the EDF.

14. The system of claim 11, wherein the EPF is configured to transmit a request for the in-band registration or a request for the out-of-band registration to the mNRF through the DEF.

15. The system of claim 11, further comprising a virtual mesh function (VMF) configured to transmit an in-band pre-registration request or out-of-band pre-registration request from the EPF to the mNRF.

16. The system of claim 11, further comprising a modified network exposure function (mNEF) configured to receive a parameter request for a virtual object from the EPF, the mNEF being configured to transmits the parameter request to a virtual application function (VAF).

17. The system of claim 16, wherein the VAF is configured to request a parameter for the virtual object through the mAMF.

18. The system of claim 11, wherein the EPF further comprises a modified network exposure function (mNEF) configured to transmit parameters for a user equipment (UE) and a virtual object to the DEF or AF.

19. The system of claim 11, wherein the EPF is configured to directly transmit an out-of-band pre-registration request to the mNRF, and
wherein the EPF is configured to indirectly transmit an in-band pre-registration request to the mNRF through a virtual mesh function (VMF).

20. The system of claim 11, wherein the EPF is configured to request a parameter for the UE to the mAMF, and
wherein the EPF is configured to transmit a parameter request for a virtual object to the mAMF through the VAF.
